(19) United States
(12) Patent Application Publication
(10) Pub. No.: US 2007/0299775 A1
(43) Pub. Date: Dec. 27, 2007

(54) Systems and methods for associating a second source of funds with an electronic check transaction

(76) Inventor: Kenneth Algiene, Littleton, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/445,615

(22) Filed: Jun. 2, 2006

(51) Int. Cl. G06Q 40/00

(52) U.S. Cl. 705/45

(57) ABSTRACT

A system automatically determines authorization and payment from a checking account of a financial transaction occurring through the presentation of a check card. For a proposed financial transaction of a customer from a merchant having a membership program, the system obtains an indication that the customer is a member of the merchant's membership program. The system determines an indication of risk for the transaction, based at least in part on the indication that the customer is a member of the merchant's membership program. The financial transaction is authorized when the indication of risk is within at least one parameter. A secondary source of funds is debited if the financial transaction from the checking account fails.

### BACKGROUND OF THE INVENTION

1. Field of the Invention

The present invention relates to the field of electronic transactions. More specifically, the invention relates to systems and methods of evaluating risk associated with electronic check transactions.

2. Description of the Related Art

Many customers are using electronic transaction technologies to pay merchants for goods and services instead of using the more traditional methods of payment, such as cash and paper checks. A debit card is one device that uses electronic transaction technology. With a debit card, a merchant knows immediately if sufficient funds exist in the customer's account to cover the payment of the goods and services.

Another electronic transaction device is a check card, such as an Automatic Clearing House (ACH) check card, which is processed electronically through the Automatic Clearing House system. One advantage for the merchant of accepting check cards is that the check card's transaction cost is less than the debit card transaction cost. However, it takes much longer to determine if sufficient funds exist in the customer's account with the check card than with the debit card.

While it is advantageous for the merchant to accept the check card to reduce costs, the merchant is taking a risk that the funds promised by the check card are not paid due to insufficient funds in the customer's account.

In order to manage financial transaction risks, some merchants subscribe to a service that accesses risk associated with financial transactions. To overcome the difficulties associated with check cards, the service may guarantee the electronic check transaction at the point of sale. The advantage to the subscribing merchant is that transactions will cost less and be substantially risk free.

### SUMMARY OF THE INVENTION

Innovative systems and methods are described to reduce the risk associated with authorizing check card electronic transactions. In an embodiment, a customer applies for a check card associated with a merchant comprising a merchant membership program. The customer supplies enrollment information such as, but not limited to the name, address, drivers license number and social security number, whether the customer is a member of a merchant membership program, years of membership in the merchant membership program, and the like.

The enrollment information further comprises account information, such as, but not limited to the account number, the bank name, MICR information, routing number, and the like, to identify a debit account, which is associated with the check card. In an embodiment, the debit account is a demand deposit account, whose balance can be drawn upon without prior notice, and is the primary source of funds used to settle promissory transactions initiated when the customer presents the check card as payment for goods and/or services.

In an embodiment, the enrollment information further comprises account information, such as, but not limited to the account number, the bank name, MICR information, routing number, and the like, to identify a secondary source of funds to debit when the primary source of funds cannot settle the promissory transaction. The secondary source of funds can be, for example, a credit card account, a debit account, another check card account, a money market account, a brokerage account, a savings account, a demand deposit account other than the primary source of funds, an electronic wire transfer, or any other account that can be debited to settle the financial transaction. In an embodiment, the secondary source of funds is a guaranteed source of funds, such as a valid credit card account. In another embodiment, the secondary source of funds is such that the merchant knows at the point-of-sale whether sufficient funds exist in the customer's account to cover the payment of the goods and services, such as, for example, an account associated with a debit card.

In another embodiment, after enrollment, systems and methods determine the risk of the transaction. When a customer presents the check card at a point-of-sale as payment for goods and/or services, a risk analysis system determines the amount of risk in accepting the proffered promissory payment. In an embodiment, the risk analysis system uses a variety of novel factors, such as, for example, whether the customer is a member of the merchant membership program, year of membership in the merchant membership program, and whether the customer has identified a secondary source of funds to debit if the primary source of funds associated with the check card fails, to determine a risk score.

In an embodiment, when the risk score exceeds a threshold or is within at least one parameter, the check card is accepted. If the primary source of funds associated with the check card is unable to settle the promissory payment due to, for example, insufficient funds in the account or account closed at the time of settlement, the merchant or the check acceptance service debits the secondary source of funds to settle the promissory transaction.

Conversely, when the risk score is below a threshold or is not within at least one parameter, the check card is not accepted. In an embodiment, when a secondary source of funds is identified at enrollment, the merchant or the check acceptance service debits the secondary source of funds to settle the promissory transaction. Thus, identifying the secondary source of funds to debit when the primary source of funds cannot settle the promissory payment reduces the risk associated with authorizing check card electronic transactions.

In an embodiment, a computer-implemented method for determining authorization of a financial transaction comprises determining whether an entity proffering a promissory payment is a member of a membership program associated with a merchant, where the promissory payment is associated with a primary source of funds and where the membership program comprises at least one secondary source of funds, determining a risk assessment of the promissory payment based at least in part on whether the entity is a member of the membership program, authorizing the promissory payment based at least in part on whether the entity is part of the membership program and based at least in part on the risk assessment, and determining whether to settle the promissory payment with the primary source of funds or the secondary source of funds.

In another embodiment, a system for determining authorization of a financial transaction comprises an indication of whether an entity proffering a promissory payment is a member of a membership program associated with a merchant, where the promissory payment is associated with a primary source of funds and where the membership program comprises at least one secondary source of funds, a risk assessment of the promissory payment based at least in part on whether the entity is a member of the membership program, an authorization of the promissory payment based at least in part on whether the entity is part of the membership program and based at least in part on the risk assessment, and a determination of whether to settle the promissory payment with the primary source of funds or the secondary source of funds.

In a further embodiment, a system for determining payment of a financial transaction through the presentation of a check card comprises means for determining whether an entity proffering a promissory payment is a member of a membership program associated with a merchant, where the promissory payment is associated with a primary source of funds and where the membership program comprises at least one secondary source of funds, means for determining a risk assessment of the promissory payment based at least in part on whether the entity is a member of the membership program, means for authorizing the promissory payment based at least in part on whether the entity is part of the membership program and based at least in part on the risk assessment, and means for determining whether to settle the promissory payment with the primary source of funds or the secondary source of funds.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 is a block diagram of an exemplary DDA card enrollment and DDA transaction processing system, according to an embodiment of the invention.

FIGS. 2, 2A, 2B illustrate a check card enrollment process, according to an embodiment of the invention.

FIG. 3 illustrates a check card transaction process, according to an embodiment of the invention.

FIG. 4 illustrates a determination process to determine whether to settle the promissory payment with the primary source of funds or the secondary source of funds, according to an embodiment of the invention.

FIG. 5 is an exemplary set of customer identification factors used to generate a check card risk analysis, according to an embodiment of the invention.

### DETAILED DESCRIPTION OF THE PREFERRED EMBODIMENT

Many times a payment for goods and/or services to a merchant is in a promissory form that instructs the customer's bank to pay the merchant from a demand deposit account (DDA). A DDA is an account, such as a checking account, whose balance can be drawn upon on demand, for example, without prior notice. Paper checks and check cards are examples of promissory payments. Other examples of promissory payments can include IOUs, credit transactions, credit cards, promissory notes, and the like.

The term “electronic check” is used to refer to several types of electronic transactions including but not limited to ACH-based electronic checking, network based electronic checking, promissory payments proffered electronically, debits initiated over the Internet or via the telephone, or the like. In ACH-based electronic checking, a payment begins as a paper check and is converted into an electronic transaction.

With network based electronic checking, a payment begins as a paper check, and is converted into, or truncated to, an electronic network entry, using networks such as an ATM network or a credit card network. The paper check is not processed.

Promissory payments proffered electronically, such as transactions initiated with a check card, begin as an electronic transaction.

With transactions that are initiated over the Internet or via the telephone, the debit is carried out by an electronic debit, usually an ACH debit. Some users categorize payments initiated via Internet or telephone but effected by paper drafts as electronic checks, even though the debit is paper-based. Electronic checking can be a catchall term used loosely to refer to any attempt to initiate payment through PCs, the Internet, and computer systems.

To reduce the risk associated with authorizing check card electronic transactions, a check guarantee service uses a transaction system to access the risk of accepting a customer's application for a check card where the customer is a member of a membership program, customer loyalty program, or the like associated with a merchant.

Further, the check guarantee service uses the transaction system to access the risk of accepting a transaction from the customer using the check card as a guarantee of payment. The risk is based at least in part on whether the customer is a member of a merchant program.

A customer provides registration information to enroll in a check card program to permit the purchase of goods and services from a merchant upon presentation of a check card. The registration information comprises an indication of whether the customer is a member of the merchant membership program and how long the customer has been a member. The registration information further comprises a second source of funds to be used for payment if the electronic checking transaction from a primary source of funds fails.

The merchant system receives the enrollment information, and generates a transaction code. The transaction code indicates the transaction is an enrollment transaction for a check card and the customer is a member of the merchant membership program. The merchant system sends the enrollment information, the transaction code, and merchant information to a transaction system.

The transaction system evaluates the risk of enrolling the customer in the check card program, based at least in part on whether the customer is member of the merchant membership program. In another embodiment, the transaction system evaluates the risk of enrolling the customer in the check card program, based at least in part on whether the customer is member of the merchant membership program and based at least in part on whether the customer has identified a secondary source of funds to debit if the customer's primary source of funds associated with the check card fails. If the risk is within at least one parameter, the transaction system notifies the merchant system that the customer's enrollment has been accepted. The parameter can be determined in various ways. For example, the parameter can be a predetermined parameter, the parameter can be a dynamic parameter, the parameter can be set by the merchant, the parameter can be set by the check acceptance service, or the parameter can be calculated by the risk assessment system on a case-by-case basis.

In an embodiment, the merchant system issues the check card to the customer. In another embodiment, the check guarantee service issues the check card to the customer. In another embodiment, the check card is a virtual check card issued to the customer over the communications medium. The check card is used to create electronic checking transactions from the customer's direct debit account, such as the customer's checking account, which is identified as the primary source of funds from which to settle promissory transactions generated by the presentation of the check card. The check card is also associated with the merchant membership program, where the merchant membership program comprises a secondary source of funds. The secondary source of funds is used to settle the promissory transactions when the primary source of funds fails.

Upon presentation of the check card at the merchant system for the purchase of goods or services, the merchant system generates a transaction code. The transaction code indicates the transaction is a purchase transaction using a check card and the check card is associated with a merchant membership program. In an embodiment, the transaction code also indicates the merchant membership program is associated with the secondary source of funds for the customer. The merchant system sends the transaction information, the transaction code, and merchant information to the transaction system.

The transaction system evaluates the risk of the transaction, based at least in part on whether the check card is associated with a merchant membership program. In another embodiment, the transaction system evaluates the risk of the transaction, based at least in part on whether the check card is associated with a merchant membership program and based at least in part on whether the customer has identified a secondary source of funds to debit if the primary source of funds fails. If the risk is within at least one parameter, the transaction system notifies the merchant system that the transaction is approved. The transaction system communicates with a clearinghouse system to debit the customer's debit account and credit the merchant's account for the amount of the purchase through an electronic checking transaction.

In an embodiment, the parameter is a predetermined parameter. In another embodiment, the parameter is a dynamic parameter. In yet another embodiment, the parameter is determined during the transaction risk evaluation. In yet another embodiment, the parameter is set by the merchant. In yet another embodiment, the parameter is set by the check acceptance service.

In an embodiment, if the electronic checking transaction fails, due to insufficient funds in the customer's debit account, for example, the customer's secondary source of funds is debited for the amount of the purchase.

In another embodiment, if the risk is not within at least one parameter, or the risk exceed a threshold, the customer's secondary source of funds is debited for the amount of the purchase.

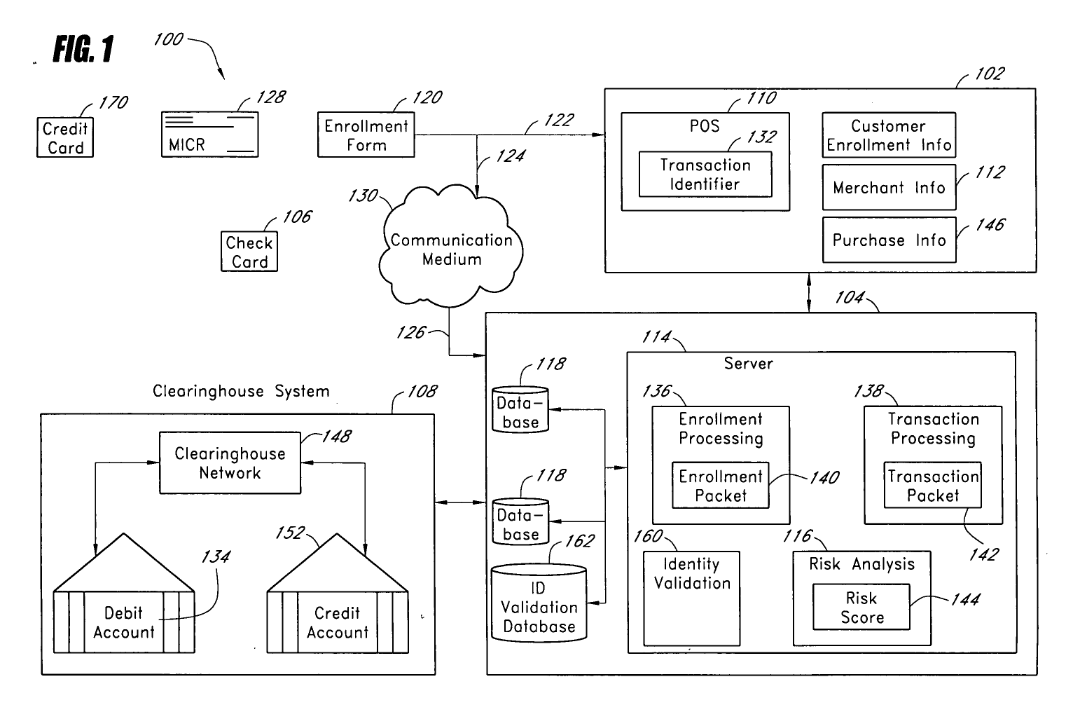

FIG. 1 is a block diagram of an exemplary check card enrollment and check card transaction processing system 100. The check card enrollment and processing system 100 comprises a merchant system 102 and a transaction system 104. The merchant system 102 and the transaction system 104 are designed to communicate with each other. FIG. 1 also shows the transaction system 104 communicating with a clearinghouse system 108. According to one embodiment, at least the merchant system 102, the transaction system 104, and the clearinghouse system 108 communicate with one another through one or more communication links.

The merchant system 102 comprises a point-of-sale device 110 and merchant information 112. In an embodiment, the point-of-sale device 110 comprises a keyboard, a display, a MICR reader, a magnetic stripe reader, a communication interface and a computer processor in communication with the communication interface.

The transaction system 104 comprises one or more server systems 114 communicating with one of more database collections 118 to determine whether to authorize particular transactions presented by the merchant system 102. In another embodiment, the database collection 118 can be provided by a third party data provider.

The database collection 118 can comprise one or more logical and/or physical data storage systems for storing the data used by the server 114. In an embodiment, the database 118 comprises an historical transaction database 118. The historical transaction database 118 stores information about the customer's financial history, and may include transaction data from transactions processed by the server 114, other systems, credit reporting companies, or other commercially available databases. The historical transaction database 118 can include information from, for example, credit reports, online activity by the customer, other customer data, and the like. The historical transaction database 118 can comprise multiple databases, such as, for example, a positive database storing positive risk information, and negative databases storing high-risk information or names of otherwise unqualified individuals.

In an embodiment, the database 118 also comprises a MICR line conversion database 118. The MICR line conversion database 118 includes information regarding the formatting of transactions submitted to the clearinghouse system 108. For example, the MICR line conversion database 118 can include historical and other information regarding the placement and use of differing MICR characters by various banking institutions or check printing companies, thereby providing the transaction system 104 with conversion information for converting the customer entered checking account data, such as the MICR line, into, for example, electronic ACH debit or credit transactions.

The server system 114 comprises enrollment processing server code 136, transaction processing server code 138, and risk analysis server code 116. The server code 116, 136, 138 includes one or more software processes or program logic designed to execute on the server systems 114. In one embodiment, the server code 116, 136, 138 may advantageously include software or hardware components such as software object-orientated components, class components, task components, processes methods, functions, attributes, procedures, subroutines, segments of program code, drivers, firmware, microcode, circuitry, data, databases, data structures, tables, arrays and variables.

As shown in FIG. 1, the transaction system 104 comprises the enrollment server code 136 for processing enrollment data and generating an enrollment packet 140, the transaction processing code for processing transaction data and generating a transaction packet 142, and the risk analysis code 116 which returns a risk score 144.

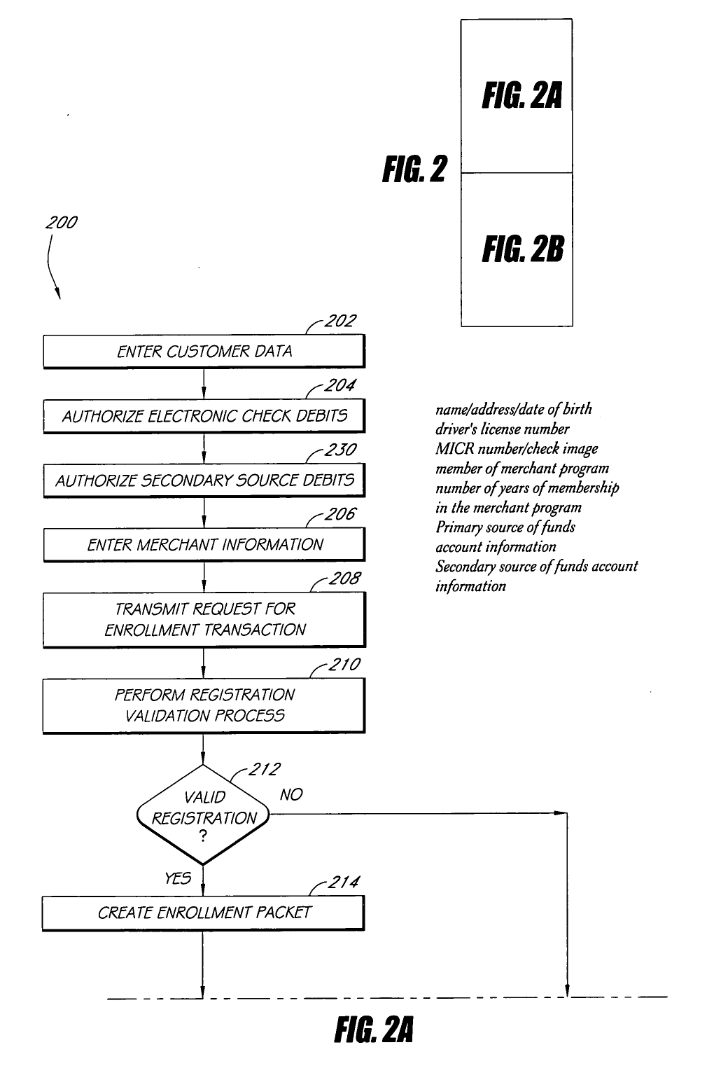

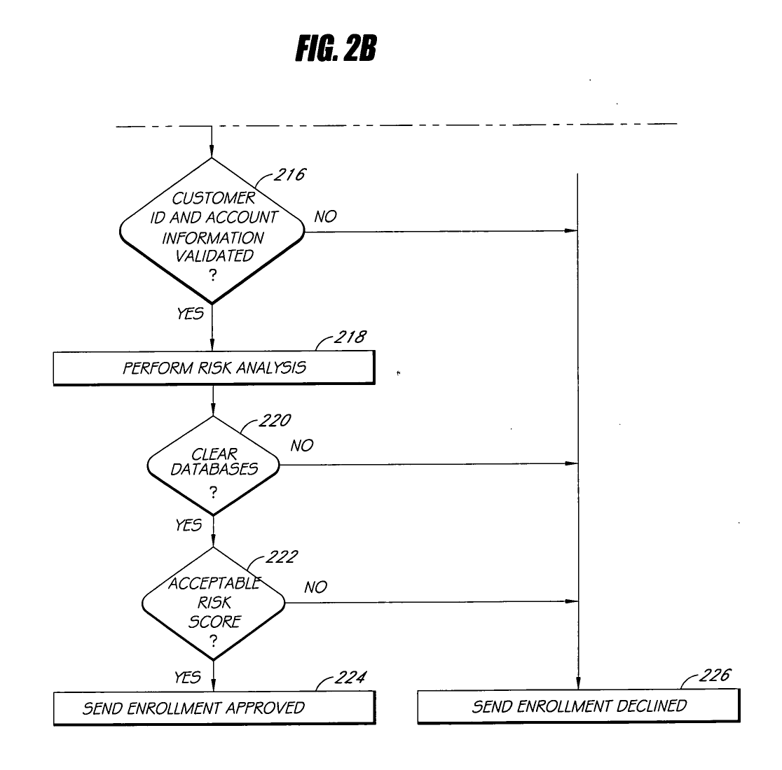

FIG. 2 illustrates a check card enrollment process 200, according to an embodiment of the invention. Referring to FIGS. 1 and 2, a customer provides registration information 120 to enroll in a check card program to acquire a check card 106 in block 202. In an embodiment, the customer registers at a merchant location, as indicated by path 122. The customer's information comprises, but is not limited to, name, address, phone number, date of birth, social security number, drivers license number, and the like. The customer's information further comprises whether the customer is a member of the merchant's membership program, and how long the customer has been a member of the merchant's membership program.

The customer's information is captured at the point-of-sale device 110. In an embodiment, the information is captured using the keyboard and display associated with the point-of-sale device 110.

The customer enrollment information further comprises account information to identify a debit account 134 to settle promissory payments generated by proffering the check card 106 for the payment of goods and/or services. The customer authorizes electronic checking transactions in block 204 by providing a bank number, account number, MICR data, or other information to identify the debit account 134. The debit account 134 is the primary source of funds for financial transactions involving the check card 106. In an embodiment, the debit account 134 is a demand deposit account 134. In an embodiment, the point-of-sale device 110 magnetically reads MICR (magnetic ink character recognition) data from a check 128 associated with the customer's debit account 134 and captures the check image.

In an embodiment, the customer information further comprises account information to identify a secondary source of funds 170 to settle the promissory payment if the primary source of funds 134 is unable to settle the promissory payment. The customer authorizes debit transactions from a secondary source of funds 170 in block 230 by providing a bank number, account number, MICR data, or other information to identify the secondary source of funds 170. The secondary source of funds 170 is associated with the customer's account in the merchant membership program and is debited if the financial transaction from the primary source of funds 134 cannot be completed.

The secondary source of funds 170 can be, for example, a credit card account, a debit account, another check card account, a money market account, a brokerage account, a savings account, a demand deposit account other than the primary source of funds 134, an electronic wire transfer, or any other account that can be debited to settle the financial transaction. In an embodiment, the secondary source of funds 170 is a guaranteed source of funds, such as a valid credit card account. In another embodiment, the secondary source of funds 170 is such that the merchant knows at the point-of-sale whether sufficient funds exist in the customer's account to cover the payment of the goods and services, such as, for example, an account associated with a debit card. In an embodiment, the secondary source of funds 170 is not directly associated with the primary source of funds 134. In an embodiment, the point-of-sale device 110 magnetically reads account information from a card, such as a credit card, or a debit card, for example, associated with the customer's secondary source of funds 170.

The point-of-sale device 110 also captures the customer's drivers license number either by keying the number from the drivers license using the keyboard or by swiping the drivers license through the card reader.

The point-of-sale device 110 generates a transaction code or identifier 132, which identifies the transaction as an enrollment for a check card in which the customer is a member of a membership program associated with the merchant.

The merchant system 102 further comprises merchant information 112, which identifies the merchant to the transaction system 104 in block 206. The merchant information 112 comprises, but is not limited to, a merchant identifier, merchant business type, merchant address, and the like.

The customer information 120, the merchant information 112, and the transaction code or identifier 132 comprise enrollment information. The merchant system 102 sends the enrollment information in a data packet and the request for enrollment approval to the transaction system 104 in block 208.

In another embodiment, the customer registers through a website via a communication medium 130 as indicated by paths 124, 126. The transaction system 104 receives the enrollment information from the website.

The communication medium 130 as shown in FIG. 1, in one embodiment, is the Internet, which is a global network of computers. In other embodiments, the communications medium 130 can be any communication system including by way of example, dedicated communication lines, telephone networks, wireless data transmission systems, two-way cable systems, customized computer networks, interactive kiosk networks, automatic teller machine networks, interactive television networks, and the like.

The transaction system 104 receives the enrollment information. In block 210, the transaction system 104 performs a registration validation process. The transaction system 104 searches for existing registrations for the customer based on at least one of the bank number, drivers license number, social security number, name, address, and the like. In an embodiment, the transaction system 104 uses the databases 118 to search for existing registrations. The transaction system 104 confirms that the customer's name, address and phone number are the same as the information provided in the enrollment information.

If, in block 212, the customer has an active registration for this merchant, the transaction system 104 declines the enrollment in block 226.

If, in block 212, the databases 118 show that the customer has been blocked from registrations, the transaction system 104 declines the enrollment in block 230.

If the customer has an existing registration from another merchant, or the transaction system 104 does not find a match in the databases 118, the transactions system 104 proceeds with the enrollment processing 136 and generates an enrollment packet 140 in block 214.

In an embodiment, the enrollment packet 140 includes, but is not limited to, account information associated with the primary source of funds 134, such as the MICR number and the bank name, the drivers license number, social security number, date of birth, name address, and phone number of the customer, a subscriber code associated with the merchant, and an indication that the customer is a member of the merchant membership program. In an embodiment, the enrollment packet 140 further comprises account information identifying the secondary source of funds 170, such as the name of the financial institution, account number, MICR number, and the like.

In an embodiment, the transaction system 104 validates the customer identification in block 216. The transaction system 104 applies an identity validation process 160 to identify and eliminate suspicious registration attempts. The identity validation process 160 looks at and updates an identity validation database 162.

In an embodiment, the transaction system 104 validates the information associated with the primary source of funds 134 in block 216 to further eliminate fraudulent registration attempts. In another embodiment, the transaction system 104 validates the information associated with the secondary source of funds 170 in block 216 to further eliminate fraudulent registration attempts. The transaction system 104 can use the database 118, comprising for example, the historical transaction database, the positive database, and the negative database, to look up and verify account information for the primary and secondary sources of funds 134, 170.

In block 218, the transaction system 104 performs the risk analysis 116 to determine the amount of risk in accepting the customer's enrollment for the check card 106. The risk analysis 116 uses risk factors unique to an enrollment transaction request for a check card 106 associated with a membership program. An indication of risk can be based, at least in part, on whether the customer is a member of a merchant membership program. Also, an indication of risk can be based, at least in part, on how long the customer has been a member of the membership program. Further, an indication of risk can be based, at least in part, on whether the membership program comprises a secondary source of funds 170 to be debited if the electronic transaction from the primary source of funds cannot settle the promissory payment. Other risk factors are, but not limited to, at least one of a success rate of prior electronic transactions associated with the customer, a success rate of prior ACH transactions associated with the customer, a historical risk associated with ACH transactions, and a risk associated with a financial institution associated with the checking account.

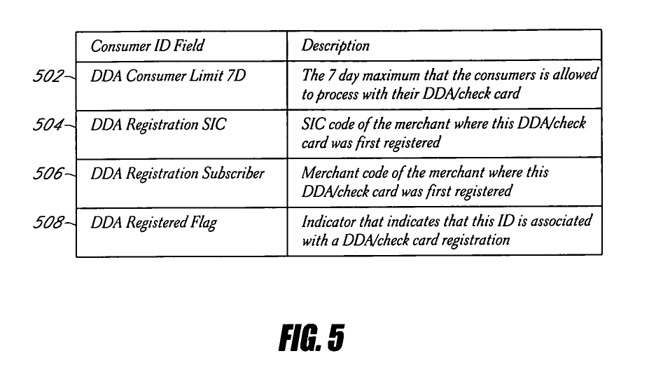

FIG. 5 illustrates an exemplary set of customer identification factors used in generating the check card transaction risk analysis 116 and is discussed in more detail below.

In an embodiment, the risk analysis 116 searches databases 118 such as, negative databases, positive databases, historical databases, and the like in block 220.

In an embodiment, the risk analysis 116 formats at least one valid transaction from the data associated with the customer's checking account 134 and processes the transaction to the clearinghouse system 108 as an electronic debit or credit to the checking account 134. Upon receiving confirmation that the transaction was properly settled, the risk analysis 116 uses the confirmation in the determination of whether to enroll the customer.

In block 222, the risk analysis code or engine 116 generates the indication of risk or the risk score 144, based at least in part, on whether the customer is a member of a membership program associated with the merchant.

The transaction system 104 accepts the customer's enrollment when the indication of risk or the risk score is within at least one risk threshold parameter. In an embodiment, the indication that the customer is a member of the merchant membership program increases the risk score 144 by an amount. In another embodiment, the indication that the customer is a member of the merchant membership program decreases the risk threshold by an amount. The risk threshold parameter and an increase or decrease of the risk score can be determined in various ways. For example, the parameter or amount can be predetermined or dynamically determined, the parameter or amount can be set by the merchant or the check acceptance service, or the parameter or amount can be calculated by the risk assessment system on a case-by-case basis.

If the risk score is within at least one parameter in block 222, the transaction system 104 notifies the merchant system 102 to accept the customer's enrollment in block 224. In an embodiment, the merchant presents the customer with the check card 106. In another embodiment, the check guarantee service presents the customer with the check card 106.

If the customer identification or account information is invalid (block 216), the enrollment information does not clear the databases (block 220), or the risk score is not within at least one parameter (block 222), the transaction system 104 sends the merchant system 102 an enrollment declined message in block 226.

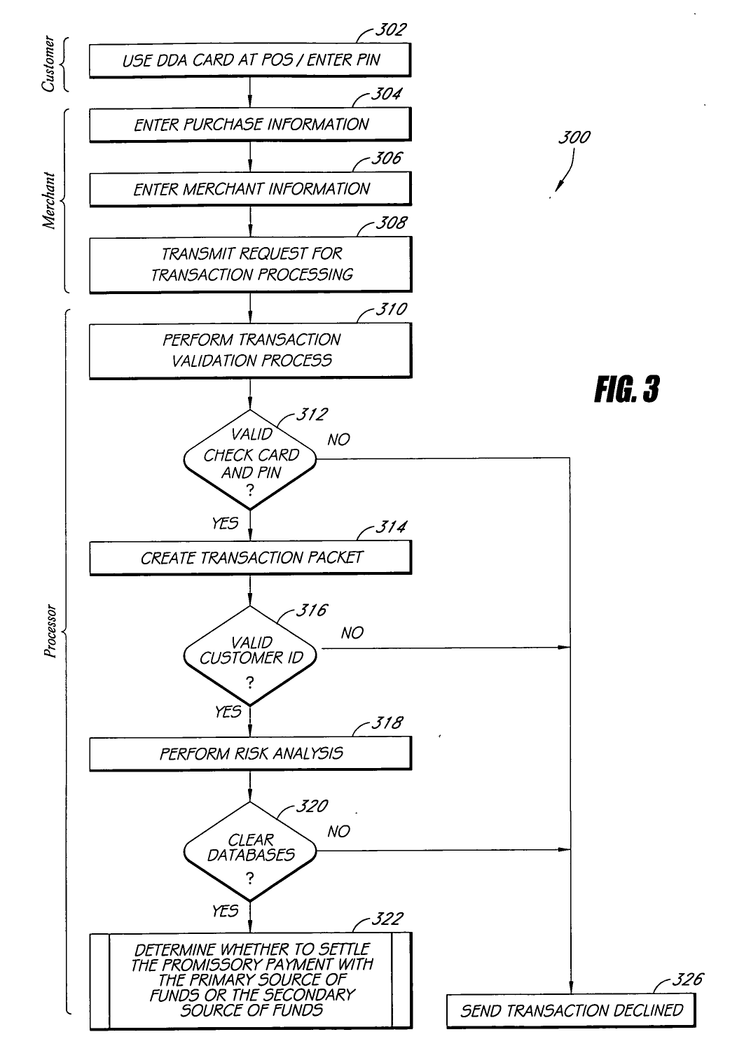

FIG. 3 illustrates a check card transaction process 300, according to an embodiment of the invention. Referring to FIGS. 1 and 3, the customer proffers a promissory payment by presenting the check card 106 at a point-of-sale to pay for goods and/or services. In an embodiment, the customer uses the check card 106 and enters a personal identification number (PIN) into the point-of-sale device 110 in block 302. The check card 106 is associated with a merchant membership program and a primary source of funds 134 as described above. In an embodiment, the membership program associated with the check card 106 is also associated with the merchant at the point-of-sale. In another embodiment, the membership program associated with the check card 106 is not associated with the merchant at the point-of-sale. In an embodiment, the membership program comprises the secondary source of funds 170 as described above.

In block 304, purchase information 146 is captured at the point-of-sale device 110. The purchase information includes, but is not limited to, customer name, address, phone number, driver's license number, item purchased, amount, date of purchase, time of purchase, check card number, and the like.

In an embodiment, the information is captured using the keyboard and display associated with the point-of-sale device 110. A card reader associated with the point-of-sale device 110 magnetically reads the account information from the check card 106. The point-of-sale device 110 also captures the customer's drivers license number either by keying the number from the drivers license using the keyboard or by swiping the drivers license through the card reader.

The point-of-sale device 110 generates the transaction code or identifier 132, which identifies the transaction as a purchase transaction for the check card 106 in which the customer is a member of a merchant membership program.

The merchant system 102 further comprises the merchant information 112, which identifies the merchant to the transaction system 104 in block 306. The merchant information 112 comprises, but is not limited to, a merchant identifier, merchant business type, merchant address, and the like.

The purchase information 146, the merchant information 112, and the transaction code or identifier 132 comprise transaction information. The merchant system 102 sends the transaction information in a data packet and the request for transaction approval to the transaction system 104 in block 308.

In another embodiment, the customer uses the check card 106 and enters a PIN at a website. The website via the communication medium 130 sends the transaction information to the transaction system 104 as indicated by the paths 124, 126.

The transaction system 104 receives the transaction information. In block 310, the transaction system 104 performs a transaction validation process to validate the check card number and PIN. If the PIN is incorrect in block 312, the transaction system 104 declines the transaction in block 326.

After the transaction system 104 confirms the check card number and PIN in block 312, the transaction system 104 proceeds with the transaction processing 138 and generates a transaction packet 142 in block 314.

In an embodiment, the transaction packet 142 can include, but is not limited to the MICR number, check card number, and the check number associated with the primary source of funds 134, the drivers license number, social security number, date of birth, amount, and a registration identifier for the customer, the subscriber code for the merchant, and an indication that the customer is a member of the merchant membership program. In another embodiment, the transaction packet includes, but is not limited to an indication that the membership program comprises the secondary source of funds 170. In an embodiment, the indication that the membership program comprises the secondary source of funds 170 can include, but is not limited to the account number, name of the account, name of the financial institution associated with the account, and the like for the secondary source of funds 170.

The transaction system 104 verifies the customer identification in block 316. In an embodiment, verifying the customer identification comprises at least one of verifying the customer's drivers license number, verifying the customer's social security number, and verifying the MICR number associated with the customer's checking account.

In block 318, the transaction system 104 performs the risk analysis 116 to determine an indication of the risk in accepting the customer's proffered promissory payment. The customer's proffered promissory payment is generated by the customer by presenting the check card 106 to the merchant for good and/or services. The risk analysis 116 uses risk factors unique to a transaction request, for a check card 106 associated with a membership program. The indication of risk can be based, at least in part, on whether the customer is a member of a merchant membership program. Also, the indication of risk can be based, at least in part, on how long the customer has been a member of the membership program. Further, the indication of risk can be based, at least in part, on whether the membership program comprises the secondary source of funds 170. Other risk factors are, but not limited to, at least one of a success rate of prior electronic transactions associated with the customer, a success rate of prior ACH transactions associated with the customer, a historical risk associated with ACH transactions, and a risk associated with a financial institution associated with the checking account.

FIG. 5 illustrates an exemplary set of customer identification factors used to generate the check card transaction risk analysis 116, and is discussed further below.

In an embodiment, the risk analysis 116 searches databases 118, such as negative databases, positive databases, historical databases, and the like, in block 320.

If the customer identification is invalid (block 316), or the transaction information does not clear the databases (block 320), the transaction system 104 sends the merchant system 102 a transaction declined message in block 326.

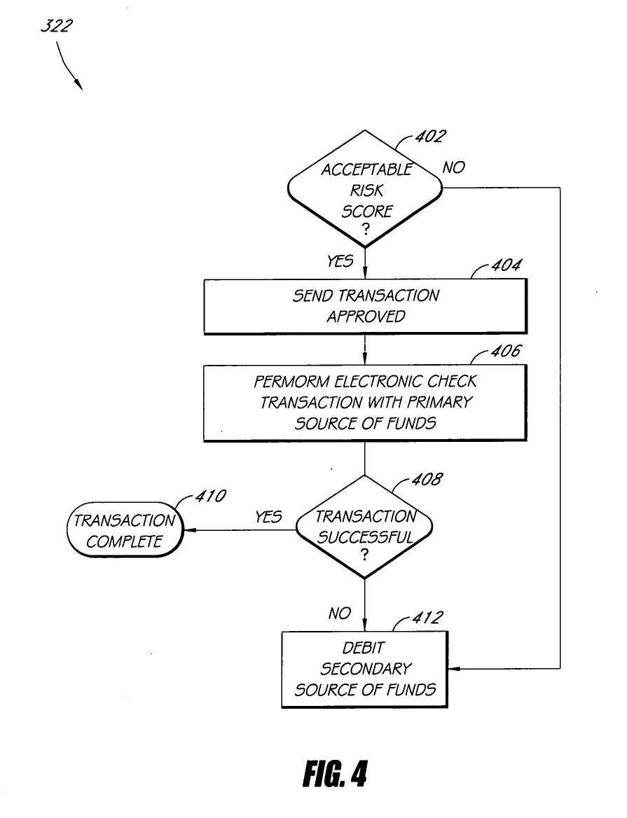

In block 322, the check card transaction process 300 determines whether to settle the promissory payment with the primary source of funds 134 associated with the check card 106 or the secondary source of funds 170 identified during enrollment in the merchant's membership program. The promissory payment determination process 322 is further described in FIG. 4.

FIG. 4 illustrates the promissory payment determination process 322, according to an embodiment of the invention. Referring to FIGS. 1 and 4, the risk analysis code or engine 116 generates the indication of risk or the risk score 144, based at least in part, on whether the customer is a member of the merchant membership program in block 402.

As will be familiar to one of skill in the art, a wide variety of methods, including ruled-based, statistical, and other methods, is available for use, alone or in combination, to construct a model for use with a risk determination system. For example, the risk determination may be created using one or more statistical methodologies, including, for example, logistic regression, linear regression, discriminant analysis, or some other modeling technique such as fuzzy logic systems, feed-forward neural networks, Bayesian or other probabilistic system. The risk determination system 116 uses the risk variables to determine the risk score 144 that indicates the determined likelihood that the promissory transaction made with the check card 106 associated with the merchant membership program will fail.

The transaction system 104 accepts the customer's promissory payment when the indication of risk or the risk score 144 is within at least one risk threshold parameter. In an embodiment, the indication that the customer is a member of the merchant membership program increases the risk score 144 by an amount. In another embodiment, the indication that the customer is a member of the merchant membership program decreases the risk threshold by an amount. The risk threshold parameter and the increase or decrease of the risk score can be determined in various ways. For example, the parameter or amount can be predetermined or dynamically determined, the parameter or amount can be set by the merchant or the check acceptance service, or the parameter or amount can be calculated by the risk assessment system on a case-by-case basis.

If the risk score 144 is within at least one parameter in block 402, the transaction system 104 notifies the merchant system 102 to accept the customer transaction in block 404.

The transaction system 104 further communicates the transaction as an electronic checking transaction to debit the customer's primary source of funds 134 to the clearinghouse system 108 in block 406. In an embodiment, the clearinghouse system 108 comprises the national ACH (Automated Clearing House) network 148. Generally, the ACH network 148 can accept electronic ACH debit and credit transactions against, for example, the customer's debit account 134. When the transaction system 104 settles a transaction between the customer and the merchant, the server 114 advantageously formats at least one electronic ACH debit transaction debiting the customer's debit account 134 and crediting a credit account 152. The electronic ACH debit and credit transactions are then transferred into the national ACH network 148 as electronic transactions. Rules for the format and content of the electronic ACH debit and credit transactions are governed by NACHA (National Automated Clearing House Association) and considered within the scope and knowledge of a skilled artisan within the electronic banking industry.

Although the clearinghouse system 108 is disclosed with reference to this embodiment, the invention is not intended to be limited thereby. Rather, a skilled artisan recognizes from the disclosure herein a wide number of alternatives to the clearinghouse system 108. For example, the clearinghouse system 108 may comprise one of more private institutions that have developed a network for clearing electronic transactions between users. Such private institutions generally promulgate rules governing the type and content of electronic transaction submissions.

If in block 408, the electronic transaction to debit the primary source of funds 134 was not successful, the customer's secondary source of funds 170 is debited for the amount of the purchase in block 412. Reasons that the electronic transaction from the primary source of funds 134 fails, include, but are not limited to, insufficient funds in the account, closed account, errors in the electronic transaction, and the like.

In an embodiment, the secondary source of funds 170 is debited at the point-of-sale. For example, the electronic transaction generated by presenting the check card can fail because of errors in reading the account number of the check card 134 by the point-of-sale device. The merchant or the check service can determine the secondary source of funds 170 associated with the customer's membership account. The merchant or the check service can charge the credit card or debit the debit account identified as the second source of funds 170 to settle the promissory payment at the point-of-sale.

In another embodiment, the secondary source of funds is debited when the merchant or the check acceptance service receives notification that the electronic transaction generated by presenting the check card 106 failed. This can be several days or weeks after the transaction. For example, the risk of accepting the check card 106 to settle the promissory payment is exceeds a risk threshold, and the transaction system accepts the check card. However, when the electronic transaction reaches the customer's bank, the account does not have sufficient funds to cover the transaction. The merchant or the check service can then charge the credit card or debit the debit account identified as the second source of funds 170 to settle the promissory payment.

If in block 402, the indication of risk or the risk score 144 is not within at least one parameter, the promissory payment determination process 322 moves to block 412, where the customer's secondary source of funds 170 is debited to settle the promissory payment. For example, when the risk score is below the risk threshold, the transaction system 104 determines that the risk of accepting the check card 106 is too high and does not accept the check card 106. The merchant or the check service can optionally process the secondary source of funds 170 to settle the promissory transaction by charging the credit card or debiting the debit account at the point-of-sale. Thus, identifying the secondary source of funds 170 to debit when the primary source of funds 134 cannot settle the promissory payment reduces the risk associated with authorizing check card electronic transactions.

As described above, a variety of factors may influence a determination of whether a transaction is to be accepted or denied. Furthermore, systems will vary the weight afforded to different factors, may exclude, or ignore certain factors while emphasizing other factors. Thus, the following customer identification factors can be considered individually or in combination when performing the risk analysis 116.

FIG. 5 illustrates an exemplary set of customer identification factors comprising a DDA consumer limit 7D 502, a DDA registration SIC 504, a DDA registration subscriber 506, and a DDA registered flag 508, which are used, at least in part, to generate the check card transaction risk analysis 116 in blocks 218 and 318. The factors The factors 502-508 are defined as follows.

The DDA consumer limit 7D factor 502 is the seven-day maximum amount that the consumer is permitted to process with their DDA/check card.

The DDA registration SIC factor 504 is the standard industry code of the merchant where the DDA/check card was first registered.

The DDA registration subscriber factor 506 is the merchant code of the merchant where the DDA/check card was first registered.

The DDA registered flag 508 is an indicator that indicates that the customer is associated with a DDA/check card registration.

In another embodiment, the customer is not be a member of a merchant's membership program, but has identified the secondary source of funds 170 to be debited if the customer's primary source of funds 134 cannot settle the proffered promissory transaction. In an embodiment, a method for determining authorization of a financial transaction comprises determining a risk assessment of a promissory payment, where the promissory payment is associated with the primary source of funds 134 and the entity proffering the promissory payment has identified the secondary source of funds 170, authorizing the promissory payment based at least in part on the risk assessment, and determining whether to settle the promissory payment with the primary source of funds 134 or the secondary source of funds 170. In an embodiment, the method further comprises settling the promissory payment with the secondary source of funds 170 when the primary source of funds 134 fails. In an embodiment, the method further comprises settling the promissory payment with the secondary source of funds 170 when the risk assessment exceeds a risk threshold.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer-implemented method for determining authorization of a financial transaction comprising:
determining whether an entity proffering a promissory payment is a member of a membership program associated with a merchant, wherein the promissory payment is associated with a primary source of funds and wherein the membership program comprises at least one secondary source of funds;
determining a risk assessment of the promissory payment based at least in part on whether the entity is a member of the membership program;
authorizing the promissory payment based at least in part on whether the entity is part of the membership program and based at least in part on the risk assessment; and
determining whether to settle the promissory payment with the primary source of funds or the secondary source of funds.

2. The method of claim 1 further comprising settling the promissory payment with the secondary source of funds when the primary source of funds fails.

3. The method of claim 1 further comprising settling the promissory payment with the secondary source of funds when the risk assessment exceeds a risk threshold.

4. The method of claim 1 further comprising:
settling the promissory payment with the primary source of funds when the risk assessment is below a risk threshold; and
settling the promissory payment with the second source of funds if the promissory payment from the primary source of funds fails.

5. The method of claim 1 wherein the secondary source of funds is a debit card account, a credit card account, a check card account, a money market account, a brokerage account, or a savings account.

6. The method of claim 1 wherein determining the risk assessment is based at least in part on the secondary source of funds.

7. The method of claim 1 wherein determining the risk assessment comprises calculating a risk score, and comparing the risk score with a predetermined risk threshold.

8. The method of claim 1 wherein determining a risk assessment comprises calculating a risk score, determining a risk threshold, and comparing the risk score with the determined risk threshold.

9. The method of claim 1 wherein the financial transaction is a promissory payment.

10. A system for determining authorization of a financial transaction comprising:
an indication of whether an entity proffering a promissory payment is a member of a membership program associated with a merchant, wherein the promissory payment is associated with a primary source of funds and wherein the membership program comprises at least one secondary source of funds;
a risk assessment of the promissory payment based at least in part on whether the entity is a member of the membership program;
an authorization of the promissory payment based at least in part on whether the entity is part of the membership program and based at least in part on the risk assessment; and
a determination of whether to settle the promissory payment with the primary source of funds or the secondary source of funds.

11. The system of claim 10 further comprising a settlement of the promissory payment with the secondary source of funds when the primary source of funds fails.

12. The system of claim 10 further comprising a settlement of the promissory payment with the secondary source of funds when the risk assessment exceeds a risk threshold.

13. The system of claim 10 further comprising:
a settlement of the promissory payment with the primary source of funds when the risk assessment is below a risk threshold; and
a settlement of the promissory payment with the second source of funds if the promissory payment from the primary source of funds fails.

14. The system of claim 10 wherein the secondary source of funds is a debit card account, a credit card account, a check card account, a money market account, a brokerage account, or a savings account.

15. The system of claim 10 wherein the risk assessment is based at least in part on the secondary source of funds.

16. The system of claim 10 wherein the risk assessment comprises a predetermined risk threshold.

17. The system of claim 10 wherein the risk assessment comprises a risk threshold calculation.

18. The system of claim 10 wherein a financial transaction is a promissory payment.

19. A system for determining payment of a financial transaction through the presentation of a check card comprising:
means for determining whether an entity proffering a promissory payment is a member of a membership program associated with a merchant, wherein the promissory payment is associated with a primary source of funds and wherein the membership program comprises at least one secondary source of funds;
means for determining a risk assessment of the promissory payment based at least in part on whether the entity is a member of the membership program;
means for authorizing the promissory payment based at least in part on whether the entity is part of the membership program and based at least in part on the risk assessment; and
means for determining whether to settle the promissory payment with the primary source of funds or the secondary source of funds.

20. The system of claim 19 further comprising means for settling the promissory payment with the secondary source of funds when the primary source of funds fails.
